(19) United States
(12) Patent Application Publication
(10) Pub. No.: US 2018/0144840 A1
(43) Pub. Date: May 24, 2018

(54) DEVICE FOR CONDITIONING RADIOACTIVE WASTE

(71) Applicant: INNOVEOX, Paris (FR)

(72) Inventor: Christian Delavaud, Nantes (FR)

(21) Appl. No.: 15/575,795

(22) PCT Filed: Apr. 19, 2016
(86) PCT No.: PCT/EP2016/058656

§ 371 Date: Nov. 20, 2017

(30) Foreign Application Priority Data
Apr. 21, 2015 (FR) 15 53565

(51) Int. Cl. G21F 9/30; G21F 9/36; B28C 7/10; B28C 7/12; B28C 7/06; B28C 5/08; B28C 5/16; B28C 5/48

(52) U.S. Cl. CPC G21F 9/304; G21F 9/36; B28C 7/10; B28C 7/12; B28C 7/06; B28C 5/0818; G21Y 2002/208; B28C 5/0812; B28C 5/168; B28C 5/48; B28C 5/0875; G21Y 2004/401; B28C 5/0862

(57) ABSTRACT

The invention relates to a device (10) for inerting radioactive waste, comprising:
a mixer (12) comprising a radioactive waste inlet (56),
a conditioning unit able to house a container,
a transfer member connecting the mixer and a container accommodated by the conditioning unit,
a handling screw, the handling screw comprising:
   two ends, one end being connected to the radioactive waste inlet (56),
   a cradle elongated along an axis between the two ends and delimiting an inner volume, the inner volume of the cradle being able to accommodate matter toward the mixer (12),
   a transfer rotor, in particular a coreless screw, extending in the inner volume, and
   a motor able to rotate the transfer rotor.

The present invention relates to a device for inerting radioactive waste.

Managing radioactive waste contributes to the safety of human health and the environment. One possibility is to encapsulate radioactive waste in packages to confine the radioactivity, while guaranteeing the mechanical and chemical strength of the package to ensure safe storage.

Document EP 2,624,257 A2 describes a radioactive waste treatment method comprising the following steps:
mixing cement and radioactive waste in a container by rotating an agitating blade at a rotation speed comprised within a predetermined interval,
monitoring a value of a control current for controlling the agitating blade during mixing,
obtaining a product mixed with cement including radioactive waste and cement by the mixing until the monitored value of the control current begins to increase by a given value, and
solidifying the mixed product with cement to manufacture a solidified product with cement.

It is desirable to automate such a method to decrease human intervention in the chain of the method. Human intervention may lead to human error, such as an inversion in a component or incorrect metering, or operator contamination.

To that end, proposed is a device for inerting radioactive waste, comprising:
a mixer comprising a radioactive waste inlet,
a conditioning unit able to house a container,
a transfer member connecting the mixer and a container accommodated by the conditioning unit,
a handling screw, the handling screw comprising:
   two ends, one end being connected to the radioactive waste inlet,
   a cradle elongated along an axis between the two ends and delimiting an inner volume, the inner volume of the cradle being able to accommodate matter toward the mixer,
   a transfer rotor, in particular a coreless screw, extending in the inner volume, and
   a motor able to rotate the transfer rotor.

According to specific embodiments of the invention, the device has one or more of the following features, considered alone or according to any technically possible combination(s):
the transfer rotor of the handling screw comprises a polyurethane, Teflon (registered trademark) or nylon coating,
the device further comprises a unit for measuring the mass of material accommodated in the inner volume delimited by the cradle,
the mixer comprises an inlet connected to a water intake and at least one inlet connected to an additive intake, the water intake and the additive intake comprising a system for metering a quantity of water and additive,
the transfer member comprises:
   a pouring channel, the pouring channel having two ends, a first end of the pouring channel being connected to the mixer and the second end of the pouring channel being connected to a container accommodated by the conditioning unit,
   a unit for sprinkling a liquid on the pouring channel, and
   a vibrating member able to vibrate the pouring channel,
the pouring channel further comprises:
   a neck, the neck being situated at the first end, the neck comprising a main axis and the neck being able to rotate around the main axis of the neck, and
   a cap, the cap being situated at the second end and the cap comprising a valve having at least an open position and a closed position,
the conditioning unit comprises a carrousel for packages, the carrousel for packages comprising:
   a chassis able to support a package, the chassis comprising rollers on which the package is intended to sit, and
   a rotation unit able to rotate the package supported by the chassis,
the conditioning unit comprises vibrating needles,
at least part of the mixer and/or the transfer member has a coating made up of at least 95% natural rubber, and
the mixer comprises:
   a vat having an inner surface, and
   a cleaning member able to send a liquid onto the inner surface.

Other features and advantages of the invention will appear upon reading the following description of embodiments of the invention, provided as an example only and in reference to the drawings, which are:

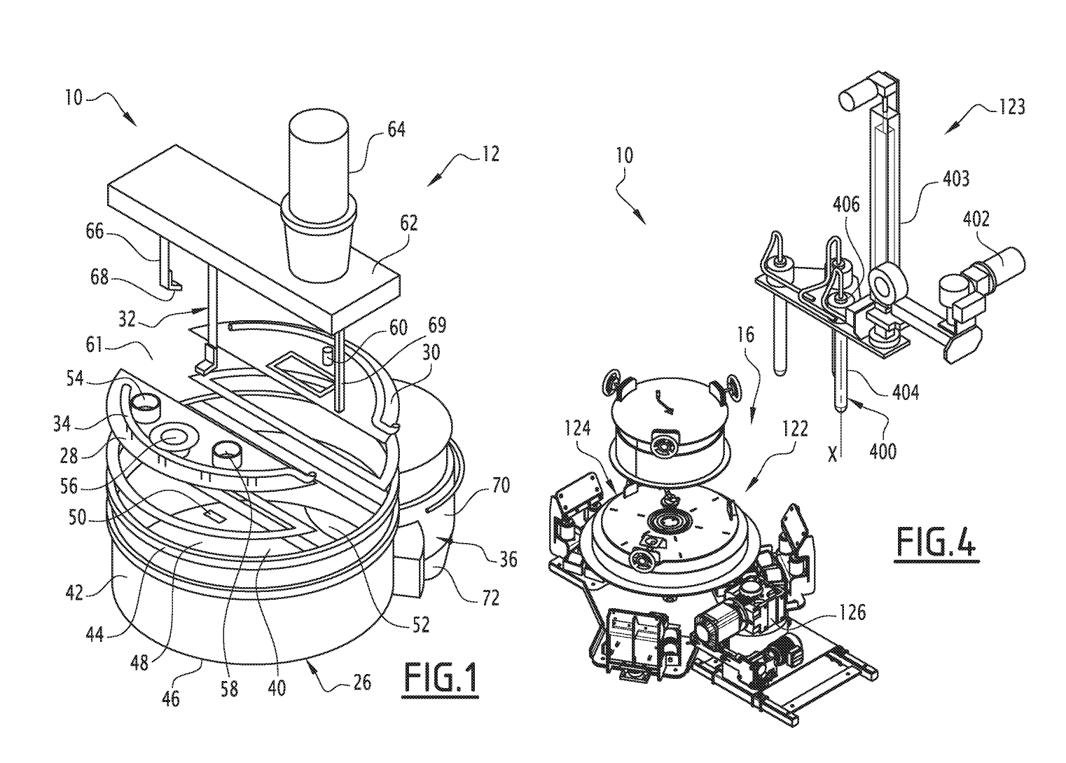

FIG. 1, an exploded perspective view of an example mixer of a device for inerting radioactive waste,

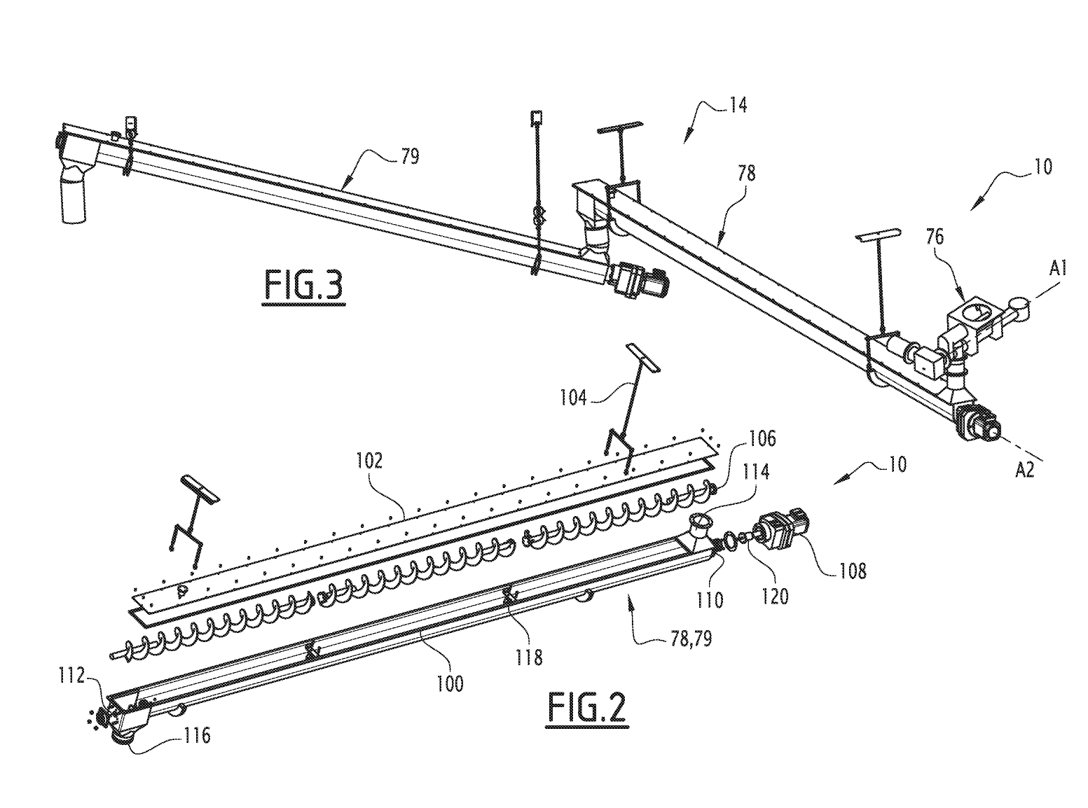

FIG. 2, an exploded perspective view of an example handling screw,

FIG. 3, an overview of an example intake member for radioactive waste from the device of FIG. 1,

FIG. 4, an exploded perspective view of an example conditioning unit of the device of FIG. 1, and

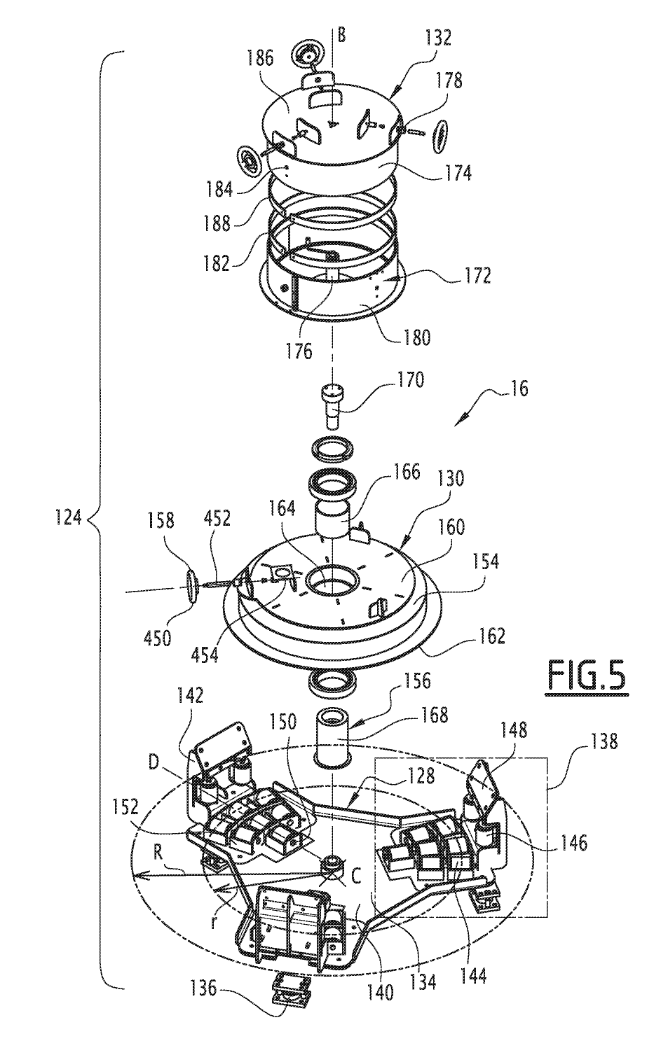

FIG. 5, an exploded perspective view of the conditioning unit of FIG. 4, with the exception of the vibrating system and the rotating unit,

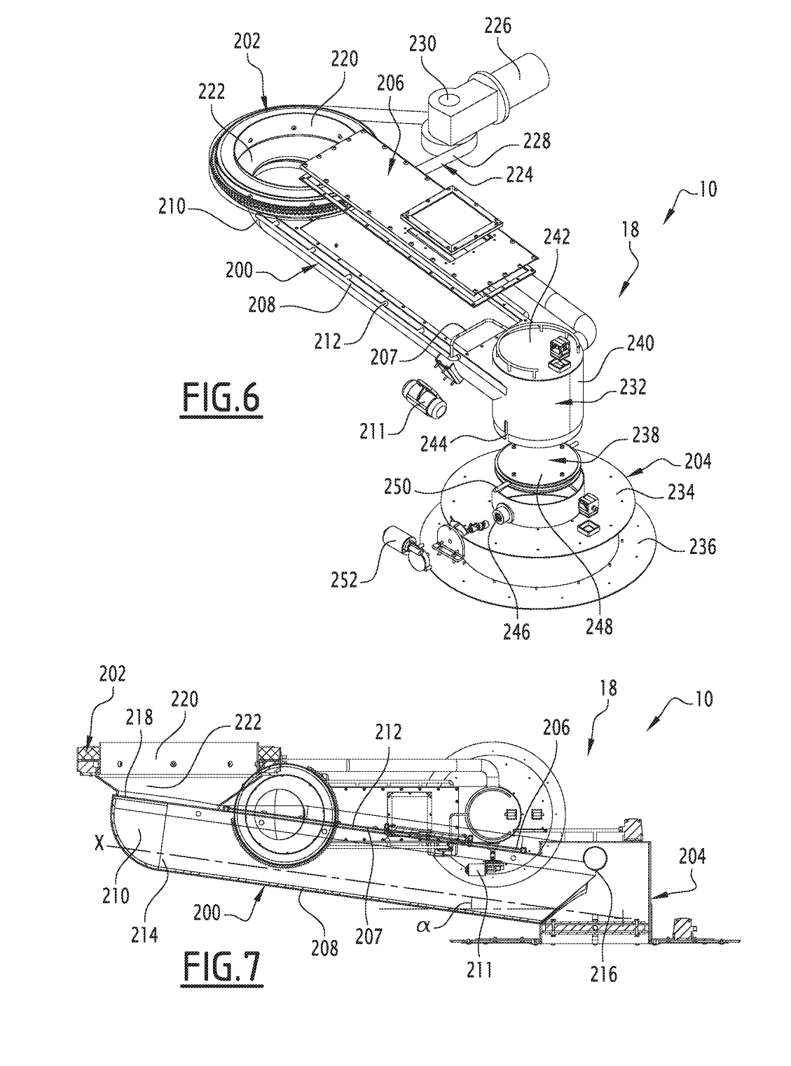

FIG. 6, an exploded perspective view of an example pouring channel of the device of FIG. 1,

FIG. 7, a cross-sectional view of the pouring channel of FIG. 6, and

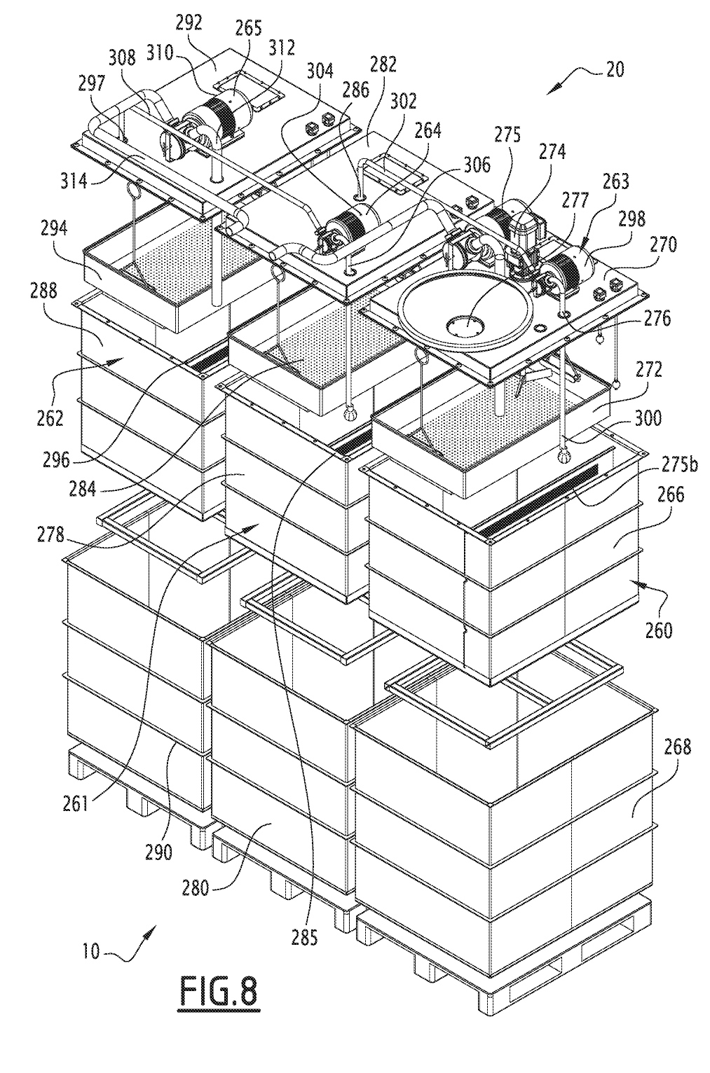

FIG. 8, an exploded perspective view of an example water treatment unit.

A device 10 for inerting radioactive waste will now be described in reference to FIGS. 1 to 8, which show parts of the device 10.

The device is configured to condition a mixture in a package. In the case at hand, the mixture comprises radioactive waste and the package has dimensions allowing storage.

The nuclear waste is for example made up of primary circuit filters, contaminated smocks and gloves, ash and clinker from melting or incineration methods.

The device 10 comprises a mixer 12, a waste intake member 14, a conditioning unit 16, a transfer member 18 and a water treatment unit 20.

The mixer 12, shown in FIG. 1, is able to mix a set of substances to produce a mixture.

In the described example, the mixer 12 comprises a vat 26, two half-covers 28, 30, at least one mixing member 32, a cleaning member 34 and an outlet neck 36.

The vat 26 defines an inner volume 40.

The vat 26 is able to store substances in the inner volume 40.

The vat 26 for example comprises a side wall 42 and a bottom 48. The side wall 42 is cylindrical with a circular base. The circular base has a radius comprised between 0.5 m and 1.1 m. The expression “comprised” means on the one hand that the radius is greater than or equal to 50 cm and on the other hand that the radius is less than or equal to 5 m.

The side wall 42 has an upper end 44 and a lower end 46. The bottom 48 is connected to the side wall 42 at the lower end 46.

The side wall 42 comprises shielding. The shielding is made from abrasion-resistant steel having a hardness comprised between 370 and 430 HB. The hardness is measured relative to the Brinell hardness. The Brinell hardness comprises a measuring method. The method consists of applying, on the shielding, a bead made from a hard material with a certain diameter D with a given force F measured in Newton for a duration t. After removal, the diameter of the imprint left d is measured. As a general rule, the bead is made from hard steel and has a diameter D equal to 10 mm. The applied force F is equal to 29,430 N. The duration t is 15 seconds. The Brinell hardness, denoted HB, is then calculated using the following formula

$$HB = \frac{2 \times F}{g \times π \times D \times ( D - \sqrt{{D}^{2} - {d}^{2}} )}$$

where g is the earth's acceleration in m/s².

The shielding has a thickness comprised between 10 mm and 14 mm, and more particularly equal to 12 mm to within 5%.

The side wall 42 is covered on the side of the inner volume 40 of the vat by a coating made up of at least 95% natural rubber. Natural rubber is a linear polymer called cis-1,4-polyisoprene with formula (C₅H₈)ₙ.

The bottom 48 has a circular shape with the same radius as the cylinder formed by the side wall 42.

The bottom 48 comprises shielding. The shielding is made from abrasion-resistant steel having a hardness comprised between 370 and 430 HB. The shielding has a thickness comprised between 13 mm and 17 mm, and more particularly equal to 15 mm to within 5%.

The bottom 48 has at least three openings 50 each provided to accommodate a sensor monitoring the hygrometry of the substance in the inner volume 40 of the vat 26.

The bottom 48 includes an edge defining an orifice 52. The orifice 52 is able to allow a substance to leave the vat 26.

The lower end 46 of the side wall 42 forms part of the edge.

In the described example, the edge is in the form of a meniscus formed by two arcs of circle. The first arc of circle is part of the lower end 46 of the side wall 42. The second arc of circle is defined in the bottom 48.

The two half-covers 28, 30 are configured to at least partially close the upper end 44 of the vat 26. The two half-covers 28, 30 are also able to accommodate intakes for various substances in the inner volume 40 of the vat 26.

The two half-covers 28, 30 are circular segments of a same disc, each made up of a chord and an arc of circle. The disc has the same contour as the circular base of the side wall 42.

The arc of circle of the circular segments has a length comprised between 0.2 times the perimeter of the circular base and 0.5 times the perimeter of the circular base. The arc of circle of the circular segments has a length comprised between 238 mm and 1300 mm.

The arcs of circle of the two half-covers 28, 30 have no common points. The chords of the two half-covers 28, 30 are parallel.

In the described example, the two half-covers 28, 30 define an orifice 61 between them.

The two half-covers 28, 30 define at least four openings: a cement inlet 54, a waste inlet 56, a sand inlet 58 and at least one liquid inlet 60.

According to the described example, the four openings 54, 56, 58, 60 are circular.

The sand inlet 58 is connected to a hose provided to convey sand to the mixer 12.

The liquid inlet 60 is an additive and/or water inlet.

In a first embodiment, the liquid inlet 60 is connected to a water distribution system.

Alternatively, the liquid inlet 60 is connected to a storage vat for an additive.

In another embodiment, the liquid inlet 60 is connected to a mixing vat, the mixing vat being connected to a water distribution system and to at least one storage vat for an additive.

The two half-covers 28, 30 are intended to rest in contact with the upper end 44 of the side wall 42.

The contact between each half-cover 28, 30 and the vat 26 is done by rubber sealing gaskets.

In one embodiment, the two half-covers 28, 30 are connected and made in a single piece.

The two half-covers 28, 30 and the vat 26 are made from the same material. The two half-covers 28, 30 are made from stainless steel.

The mixing member 32 is able to mix a substance in the inner volume 40 of the vat 26.

The mixing member 32 comprises a support 62, a motor 64 and planetary rotating blades 66.

The support 62 is configured to support the planetary rotating blades 66 and the motor 64. The support 62 is also provided to close the vat 26 at its upper end 44.

The support 62 is in the shape of a rectangle. The rectangle has a length and width. The length is greater than the size of the diameter of the circular base of the side wall 42. The width is greater than the distance between the two chords of the two half-covers 28, 30.

The support 62 is intended to rest in contact with the upper end 44 of the vat 26.

Alternatively, the support 62 is intended to rest in contact with the upper end 44 of the vat 26 and with the two half-covers 28, 30.

The length of the support 62 is placed parallel to the chords of the two half-covers 28, 30. The support 62 is arranged to cover the orifice 61 between the two half-covers 28, 30.

The support 62 is made from painted alloyed steel.

The support 62 comprises a planetary reducing gear.

The planetary reducing gear is provided to rotate the planetary rotating blades 66.

The planetary reducing gear comprises a planetary gear train making it possible to transmit torque from a motor to the planetary rotating blades.

The planetary reducing gear is situated outside the inner volume 40 of the vat 26. The planetary reducing gear is fastened to the support 62.

The motor 64 is an electric motor.

The motor 64 is provided to start the planetary rotating blades 66, more particularly when the inner volume of the mixer 12 comprises a substance.

The planetary rotating blades 66 are configured to mix a substance in the inner volume 40 of the vat 26, when the planetary rotating blades 66 are set in motion.

The planetary rotating blades 66 make up a member comprising a central part, several arms elongated between two ends and a lateral scraper 69.

At a first end, the arms are provided with scrapers 68. At the second end, the arms are connected to the central part.

The lateral scraper 69 is in contact with the side wall 42 of the vat 26. The lateral scraper 69 is able to scrape the side wall 42 of the vat 26 when the planetary rotating blades 66 are rotating.

The planetary rotating blades 66 are positioned in the inner volume 40 of the vat 26. The central part is mounted on the support 62 in connection with the planetary reducing gear. The scrapers 68 are in contact with the bottom 48. The arms of the planetary rotating blades and the lateral scraper 69 are elongated between the support 62 and the bottom 48 of the vat 26.

The planetary rotating blades 66 are able to be rotated around the main axis of the cylindrical vertical wall 42 by the planetary reducing gear.

The planetary reducing gear 66 is made from stainless steel. The arms of the planetary reducing gear are covered with a coating made up of at least 95% natural rubber.

The cleaning member 34 is configured to splash the inner volume 40 of the vat 26 with a liquid.

The cleaning member 34 is able to splash the side wall 42 of the vat 26, the bottom 48 and the two half-covers 28, 30.

The cleaning member 34 comprises a collector and a set of nozzles.

The collector is configured to convey water and to splash water on the side wall 42 of the vat 26, the bottom 48 and the two half-covers 28, 30.

A first splashing with water is done by the collector, at a low pressure substantially equal to atmospheric pressure, and with a high flow rate. The flow rate is comprised between 15 and 20 m³/h.

The collector comprises one or several hoses connecting the inner volume 40 of the vat and a water distribution system.

The nozzles are able to splash water on the side wall 42 of the vat 26, the bottom 48 and the two half-covers 28, 30.

A second splashing with water is done by the nozzles, at a high pressure comprised between 125 and 175 bars, and substantially equal to 150 bars.

The nozzles are mounted on the planetary rotating blades 32. When the planetary rotating blades 32 begin to rotate, the nozzles are also driven in rotation.

The nozzles are oriented toward the side wall 42 of the vat 26, the bottom 42 and the cover 28.

Furthermore, in the described example, the nozzles are mounted translatably. The nozzles are able to sweep a surface.

The nozzles are on the one hand connected to one another and on the other hand connected to a system for pressurized water distribution by one or several hoses.

The outlet neck 36 is able to prevent a substance from leaving the vat 26, or to allow it to do so.

The outlet neck 36 defines an inner volume. The outlet neck 36 is attached to the vat 26 at the orifice 52.

The outlet neck 36 comprises an upper surface 70 and a funnel 72.

The upper surface 70 delimits an upper volume.

The upper surface 70 has a cylindrical shape with a crescent-shaped base. The upper surface 70 comprises two vertical surfaces and a cover, but no bottom.

The two vertical surfaces comprise a lower end. The lower end of the two vertical surfaces is substantially at the same height as the lower end 46 of the vat 26.

The crescent comprises two sides. The sides are each in the form of an arc of circle: an inner arc of circle and an outer arc of circle. The outer arc of circle is the arc of circle having the greatest length.

The side formed by the inner arc of circle extends against part of the vertical wall 42. The lower end of the side formed by the inner arc of circle is combined with the first arc of circle of the orifice 52.

The lower end of the side formed by the outer arc of circle forms a circle with the second arc of circle of the orifice 52.

The funnel 72 is in the shape of a truncated cone. The cone extends around a vertical main axis. The funnel 72 has an upper end and a lower end. The funnel 72 is open at both of its ends. The surface of the cutting circle of the cone decreases from the upper end to the lower end.

The funnel 72 is connected at its upper end to the upper volume 70 and to the vat 26 at the orifice 52.

The shape of the funnel 72 at its upper end is the circle formed by the outer arc of circle of the crescent and the second arc of circle of the orifice 52.

The funnel 72 defines, at its lower end, an outlet of the outlet neck 36.

The outlet neck 36 has at least two positions: an open position and a closed position.

When the outlet neck 36 is in the closed position, the outlet neck 36 prevents any substance contained in the vat 26 from leaving it.

A door for example closes the orifice 52 of the bottom 48 when the outlet neck 36 is in the closed position. The door has a shape complementary to the orifice 52.

When the outlet neck 36 is in the open position, the outlet neck 36 is an outlet from the vat 26.

The door at least partially frees the orifice 52 of the bottom 48 when the outlet neck 36 is in the open position.

The outlet neck 36 and the vat 26 are made from the same material. The outlet neck 36 is made from stainless steel.

The waste intake member 14 is able to bring radioactive waste toward the mixer 12. The intake member for waste 14 and the mixer 12 are configured so that the radioactive waste is poured into the inner volume 40 of the vat 26.

The waste intake member 14 is able to measure the quantity of radioactive waste poured into the inner volume 40 of the vat 26. The waste intake 14 is able to stop pouring radioactive waste when a predetermined quantity is reached.

The waste intake member 14 comprises two ends. A first end is connected to a radioactive waste storage area. A second end is connected to the waste inlet 56 defined in one of the half-covers 28.

In the described example, the waste intake member 14 comprises a lump breaker screw 76 and one or several handling screws 78, 79 placed end to end.

The lump breaker screw 76 is configured to break and convey the radioactive waste.

The lump breaker screw 76 comprises a body, a lump breaker shaft, a coreless screw and a motor.

The body of the lump breaker screw 76 is elongated between two ends along an axis A1. The body of the lump breaker screw 76 defines an inner volume.

The body of the lump breaker screw comprises a material inlet on the top and a material outlet at one end of the body of the lump breaker screw 76.

The lump breaker shaft is elongated along the axis A1. The lump breaker shaft has two ends. The lump breaker shaft is mounted on the body of the lump breaker screw 76, such that the lump breaker shaft is freely rotating around the axis A1. The lump breaker shaft is situated below the material inlet of the body of the lump breaker screw.

The lump breaker shaft comprises a central core and blades mounted on the central core. The lump breaker shaft is able to break the material.

The coreless screw is elongated along the axis A1 in the body of the lump breaker screw 76.

The coreless screw comprises two ends. The first end of the coreless screw is at the material outlet of the body of the lump breaker screw. The coreless screw is situated below the material inlet of the body of the lump breaker screw and the lump breaker shaft.

The coreless screw is able to convey material from the material inlet to the material outlet.

The motor is able to rotate the lump breaker shaft and the coreless screw. The motor is able to rotate the coreless screw via a sleeve. One of the ends of the lump breaker shaft and the second end of the coreless screw are connected by a chain. Thus, the lump breaker shaft is rotated by the coreless screw, the coreless screw being rotated by the motor.

The lump breaker screw 76 is configured so that the material that enters through the material inlet falls on the lump breaker shaft. The material in contact with the lump breaker shaft next comes into contact with the coreless screw. The coreless screw guides the material toward the material outlet.

The handling screw 78, 79, shown in FIG. 3, is configured to convey the radioactive waste to the vat 26 of the mixer 12.

The handling screw 78, 79 comprises a cradle 100, a lid 102, at least one support 104, a transfer rotor 106 and a motor 108.

The handling screw 78 is elongated along an axis A2.

The cradle 100 defines an inner volume elongated along the axis A2. The inner volume of the cradle 100 is able to contain the material to be conveyed.

The cradle 100 comprises two ends 110, 112 along the axis A2.

The cradle 100 comprises, at a first end 110, a material inlet 114, and at a second end 112, a material outlet 116. The material inlet 114 is hermetically connected to the material outlet of the lump breaker screw 76.

The material outlet 116 is hermetically connected to the waste inlet 56 of the mixer 12.

The cradle 100 is for example in the form of a slab elongated along the axis A2. The cradle 100 comprises substantially vertical walls and a bottom, but no lid. The cradle 100 has an upper edge.

In the described example, the material inlet 114 is an inlet neck. The inlet neck is situated in contact with the upper edge of the cradle 100.

The material outlet 116 is an outlet neck defined in the bottom of the cradle 100.

The cradle 100 is made from stainless steel.

The lid 102 is configured to hermetically close the cradle 100.

The lid 102 is in the form of a rectangle able to be superimposed on the upper edge of the cradle 100, with the exception of the material inlet 114. The lid 102 is configured to leave a passage for the material inlet 114.

The support 104 is provided to maintain the cradle 100. The support 104 is able to measure a representative mass of the material in the handling screw 78, 79.

In the described example, the support 104 is a hanger connecting the cradle 100 to a roof or chassis.

The support 104 is equipped with a weight indicator. The weight indicator is able to measure the mass of the material in the inner volume of the cradle 100.

The transfer rotor 106 is able to rotate in the inner volume of the cradle 100 and to drive the material from the material inlet 114 to the material outlet 116.

The transfer rotor 106 is elongated along the axis A2. The transfer rotor 106 extends from one end 110 of the cradle 100 to the other end 112 of the cradle 100.

The transfer rotor 106 is mounted rotating at the ends 110, 112 of the cradle 100. The transfer rotor 106 extends in the inner volume of the cradle 100.

The transfer rotor 106 comprises a polyurethane, Teflon (registered trademark) or nylon coating.

In the described example, the transfer rotor 106 is a coreless screw.

The coreless screw is made up of three similar parts connected by bearings 118. The bearing 118 is a shell provided with a through central orifice. The central orifice bears a sliding ring. The sliding ring is made from nylon. A first part of the coreless screw 106 is mounted on the bearing 118 at one end of the central orifice. A second part of the coreless screw 106 is mounted on the bearing 118 at another end of the central orifice. The two parts of the coreless screw 106 thus mounted are secured in rotation around the axis A2.

The motor 108 is able to rotate the transfer rotor 106.

The motor 108 is connected to the coreless screw at an end 110 of the cradle by a coupling sleeve 120. The coupling sleeve 120 is configured to transmit the torque from the motor 108 to the transfer rotor 106.

The motor 108 is configured to rotate the transfer rotor 106 around the axis A2 in both possible rotation directions. In a first rotation direction, the coreless screw 106 is able to convey material from the material inlet 114 to the material outlet 116. In a second rotation direction, the transfer rotor 106 is able to convey material from the material outlet 116 to the material inlet 114.

Alternatively, the motor 108 is configured to rotate the transfer rotor 106 around the axis A2 in only the first rotation direction.

The motor 108 has a power comprised between 2 and 2.5 kW.

In the case where the waste intake member 14 comprises several handling screws, the material inlet 114 of the first handling screw 78 is connected to the material outlet of the lump breaker screw 76 and the material outlet 116 of the second handling screw 79 is connected to the waste inlet 56 of the mixer. The material inlet 114 of each handling screw 79 different from the first handling screw 78 is mounted on the material outlet 116 of the preceding handling screw 78. The material outlet 116 of each handling screw 78 different from the last handling screw 79 is mounted on the material inlet 114 of the following handling screw 79.

The conditioning unit 16, shown in FIGS. 4 and 5, comprises a carrousel for packages 122 and a vibrating system 123.

The package carrousel 122 is able to support a container for conditioning radioactive waste and rotating the container.

The container is substantially a cylinder having a vertical axis as generatrix, closed at its lower end and open at its upper end.

The container defines an inner volume. The container contains between 100 and 1000 liters.

The package carrousel 122 comprises a chassis 124 and a rotating unit 126.

The chassis 124 is configured to support a container.

The chassis 124 comprises a base 128, a first lifting system 130 and a second lifting system 132.

The base 128 comprises a support 134, feet 136 and sliding stations 138.

The support 134 comprises a surface 140 and vertical supports 142.

The support 134 is invariant by 120° rotation around a center C.

The surface 140 of the support 134 has a planar shape.

The surface 140 of the support 134 is included in a circle with center C and first radius R and is not included in a circle with center C and second radius r. The difference R-r is less than 10 cm. The first radius R is comprised between 0.5 m and 5 m. The second radius r is comprised between 0.6 m and 5.1 m.

In an example that is not illustrated, the surface 140 of the support 134 is a disc with center C.

The vertical supports 142 comprise a lower part, an upper part and a vertical part.

The lower part is mounted on the surface 140 of the support 134. In the described example, the lower part is a slab.

The upper part is in the form of a bevel. The upper part comprises two triangular vertical surfaces, a lower horizontal rectangular surface, a vertical rectangular surface and a diagonal rectangular surface.

The vertical part connects the lower part and the upper part. The vertical part is substantially a slab elongated along the vertical axis.

The vertical supports 142 are U-shaped. The cavity of the U is oriented along a horizontal plane and toward the center C.

There are three vertical supports 142. In the described example, the vertical supports 142 are situated at the apices of the surface 140 of the support 134.

The feet 136 are configured to bear the support 134.

The feet 136 keep the support 134 horizontal. The feet 136 are provided to rest on a horizontal floor. The feet 136 are identical.

The feet 136 are placed on a circle, the center of which is the center of the support. The feet 136 are situated at a certain distance D from the center. The distance D is comprised between 0.75 times the second radius r and the second radius r.

There are three feet 136, which are placed at 120° from one another on the circle. In the described example, the feet 136 are in contact with the support 134 at the apices of the support 134.

Each foot 136 is equipped with a weight indicator. The weight indicators are able to measure the mass of material contained in a container being supported on the package carrousel 122.

The sliding stations 138 are able to facilitate the rotational movement around the vertical axis B passing through C of a package supported by the chassis 124.

The sliding stations 138 are mounted on the support 134.

In the described example, the chassis 124 comprises three sliding stations 138.

The sliding stations 138 are evenly angularly distributed. For example, the sliding stations 138 are distributed at 120°.

The sliding stations 138 are situated at 120° from one another around C. The sliding stations 138 are invariant by 120° rotation around C.

The sliding stations 138 are situated between the vertical supports 142 and the center C.

The sliding stations 138 each comprise bearing rollers 144, lateral rollers 146 and a sliding strip 148.

In the described example, each sliding station 138 comprises seven bearing rollers 144, two lateral rollers 146 and a sliding strip 148.

The bearing rollers 144 are similar rollers. The bearing rollers 144 are hollow circular cylinders with an axis d as generatrix. The bearing rollers 144 have a cylindrical through orifice with axis d as generatrix.

The bearing rollers 144 are made from stainless steel and have a polyurethane coating.

The bearing rollers 144 are mounted rotating on rods 146. One or several bearing rollers 144 are mounted on a rod 150. The rods 150 are introduced into the through orifice of the bearing rollers 144.

The rods 150 are mounted on the support 134. The main axis d of the bearing roller 144 and the rods is horizontal. The intersection between the generatrix d of the bearing roller 144 and the vertical axis B passing through the center C is a point.

In the described example, the support 134 comprises seven units 152 per sliding station 138. The units 152 are able to receive a bearing roller 144. The rods 150 are mounted on vertical walls of the unit 152.

The lateral rollers 146 are similar to the bearing rollers 144.

Each lateral roller 146 is mounted on a rod. The rod is inserted into the through orifice of the lateral roller 146.

The rod is mounted rotatably at one of the vertical supports 142 of the support 134. The rod extends along the main axis between the lower part and the upper part of the vertical support. The generatrix of the lateral roller 146 is vertical.

The lateral rollers 146 are situated at an equal distance from the center C.

The sliding strip 148 is a rectangular plate fastened on the rectangular surface in diagonal with the upper part of the vertical supports 142. The sliding strip is made from nylon.

The first lifting system 130 and the second lifting system 132 are configured so that the upper end of a container is situated at the same height from the ground as in the case of another container with a different capacity.

The first lifting system 130 comprises a first lift 154, a guide system 156 and a tightening wheel 158.

The first lift 154 is substantially in the form of a hollow cylinder. The cylinder has a circular base and vertical axis B as generatrix. The first lift 154 has a radius smaller than the distance r.

The first lift 154 comprises an upper horizontal surface 160 and a lower horizontal surface 162. The upper horizontal surface 160 and the lower horizontal surface 162 have a distance comprised between 0.1 m and 0.2 m, and more particularly equal to 164 mm.

The first lift 154 defines an orifice 164. The orifice 164 is cylindrical with a circular base. The orifice 164 traverses the first lift 154 between the upper horizontal surface 160 and the lower horizontal surface 162.

The lower horizontal surface 162 of the first lift 154 rests on the bearing rollers 144 of the base 128. The first lifting system 130 is removable relative to the base 128.

The guide system 156 is configured to guide the first lift 154 in rotation around the axis B.

The guide system 156 extends in the orifice 164. The guide system 156 comprises rolling bearings 166 mounted on a pin 168 having the axis B as its main axis. The rolling bearings 166 are configured so that the first lift 154 is able to rotate around the axis B. The guide system 156 comprises a blocking screw 170 to keep the rolling bearings 166 and the pin 168 secured.

The tightening wheel 158 comprises a wheel 450, a tightening screw 452 and a bearing pad 454.

The wheel 450 and the tightening screw 452 are secured in rotation.

The tightening screw 452 is mounted rotatably on the first lift 154 with a nut.

The bearing pad 454 is mounted on the tightening screw 452 and is able to be translated by the tightening screw 452 between a gripping position and a free position.

In the gripping position, the bearing pad 454 is in contact with the second lifting system 132, if the second lifting system 132 is raised, or if not, with the container.

In the free position, the bearing pad 454 is not in contact with the second lifting system 132 or the container.

When the wheel 450 rotates in one direction, the tightening screw 452 rotates in the same direction and moves the bearing pad 454 from the gripping position to the free position.

When the wheel 450 rotates in the other direction, the tightening screw 452 rotates in the same direction and moves the bearing pad 454 from the free position to the gripping position.

The wheel 450 is provided to be immobilized by a dowel.

The second lifting system 132 comprises an inner shell 172, an outer shell 174, an adjusting crank 176 and at least one tightening wheel 178.

The inner shell 172 comprises a side wall 180. The side wall 180 has a cylindrical shape with a circular base and the axis B as generatrix. The side wall 180 has an inner surface and an outer surface. The outer surface of the side wall 180 has a radius smaller than the radius of the first lift 154.

The side wall 180 rests on the upper horizontal wall 160 of the first lift 154.

The inner shell 172 comprises a nylon ring 182. The ring 182 is mounted on the outer surface of the inner shell 172.

The outer shell 174 comprises a side wall 184, an upper horizontal wall 186 and a nylon ring 188.

The side wall 184 has a cylindrical shape with a circular base and the axis B as generatrix. The side wall 184 has an inner surface and an outer surface.

The side wall 184 of the outer shell 174 has a diameter smaller than the diameter of the side wall 180 of the inner shell 172 by a distance comprised between 4 mm and 8 mm, and more particularly equal to 6 mm to within 5%.

The ring 188 is mounted on the inner surface of the outer shell 174. The outer surface of the inner shell 172 and the inner surface of the outer shell 174 are in contact at the rings 182, 188.

The upper horizontal wall 186 rests on the side wall 184. The upper horizontal wall 186 is a disc, having a diameter comprised between the diameter of the side wall 184 and 1.1 times the diameter of the side wall 184.

The inner 172 and outer 174 shells are able to slide relative to one another in translation along a vertical axis. The inner shell 172 being in contact with the first lift 154, the height of the outer shell 174 relative to the first lift 154 is variable.

The adjusting crank 176 is provided to adjust the height of the outer shell 174.

In the described example, the adjusting crank 176 comprises a screw/nut system making it possible to raise or lower the outer shell 174 relative to the first lift 154.

The tightening wheel 178 of the second lift system 132 is configured to grip the container on the second lift system 132. The tightening wheel 178 of the second lift system 132 is similar to the tightening wheel 158 of the first lift system 130.

The second lift system 132 is removable from the first lift 154.

The rotating unit 126 is able to rotate a container or the first lift system 130.

The rotating unit 126 comprises a gear motor mounted on rails.

The gear motor is able to rotate an object in contact with the gear motor. The gear motor is at a height from the ground substantially equal to that of the first lift system 154.

The rails are parallel and are configured to bring the gear motor closer to or further from the chassis 124.

The vibrating system 123 comprises at least a vibrating needle 400, an outside connector 402 and a support 403.

The vibrating needle 400 is configured to generate vibrations.

The vibrating needle 400, shown in FIG. 4, comprises a body 404, a weight and a rotating system.

The body 404 is substantially in the form of a closed rigid tube elongated along the main axis X. The body defines an inner volume.

The vibrating needle 400 extends primarily along the main axis X of the body 404.

The body 404 has two ends. At one end, the body 404 comprises a connecting system 406. The connecting system 406 allows the connection of the outside connector 402 to the body of the vibrating needle 400.

The body 404 is made from a material comprising stainless steel.

The weight is situated in the inner volume of the body.

The weight is off-centered relative to the main axis X of the body of the vibrating needle 400. The center of gravity of the weight is not situated on the main axis X of the body of the vibrating needle 400.

The weight is able to be rotated by the rotating system. The rotation of the weight occurs around the main axis X of the body of the vibrating needle 400. The rotation of the weight is done at a predetermined frequency.

The rotating system is for example a rod connecting the weight to the connecting system. The rod is able to be rotated around the axis X by a motor.

Alternatively, the rotating system is a rotor of a motor along the axis X on which the weight or another compressed air system is mounted establishing a stream of air able to rotate the weight around the axis X.

The outside connector 402 is able to activate the rotating system of the vibrating needle 400.

The outside connector 402 is situated outside the inner volume of the body 404 of the vibrating needle 400.

The outside connector 402 is connected to the body 404 of the vibrating needle 400 at the connecting system.

Depending on the nature of the rotating system, the outside connector 402 is a motor, an electric motor or a compressed air system. The connecting system 406 is then a driving device, a power outlet or an opening defined by the body 404.

The support 403 is configured to maintain and move the vibrating needle 400.

The support 403 is able to move the vibrating needle(s) 400 between at least two positions: an idle position, in which the vibrating needle 400 is not aligned with the rotating package table, and a vibrating position, in which the vibrating needle 400 is configured to be at least partially in the inner volume of a container accommodated by the rotating package table 122.

The support 403 is commanded automatically or manually.

The support 403 is for example made from stainless steel.

The transfer member 18 is configured to transfer a substance from the mixer 12 to a container in contact with the conditioning unit 16.

The transfer member 18 comprises a pouring channel 200, a rotary neck 202, a cap 204, a lid 206 and a washing system 207.

The pouring channel 200 is configured for the flow of a substance in contact with the transfer member 18.

The pouring channel 200 comprises a main part 208, an insertion area 210 and a vibrating member 211.

The main part 208 of the pouring channel extends between two ends. The main part 208 has a slope.

In the described example, the central part 208 is substantially in the shape of part of a truncated hollow cylinder with an axis X as generatrix. The axis X forms an angle α with any horizontal plane. The cylinder is truncated along a plane parallel to the axis X, the part of the cylinder situated above the plane being removed. The truncating plane forms a constant angle with a horizontal plane, the angle being equal to the angle α.

The main part 208 of the pouring channel 200 is inclined along the angle α. The angle α is greater than 20°.

The intersection between the truncating plane and the cylinder forms upper edges 212 of the central part 208.

The two ends of the main part 208 are an upper element 214 and a lower element 216. The upper end 214 is situated at a height greater than that of the lower end 216.

At the lower end 216, the central part 208 is cut on a slant. The size of the central part 208 along the axis X is maximal at its upper edges 212.

The inner face of the central part 208 includes at least one coating made up of at least 95% natural rubber.

The insertion area 210 is configured to close one end of the central part 208 and is able to allow a substance to enter the pouring channel 200.

The insertion area 210 is fastened to the upper end 214 of the central part 208.

The central part 208 and the insertion area 210 are made in a single piece or are made in two separate parts, then attached to one another.

The insertion area 210 extends moving away from the central part 208.

The insertion area 210 comprises an inner face and an outer face. The inner face and the outer face of the insertion area 210 are delimited at two borders, one being in contact with the central part and the other being an upper edge 218.

The insertion area 210 is in the form of a quarter-ball. The border in contact with the central part 208 has substantially the same shape as the upper end 214 of the central part 208.

The inner face is the face intended to be in contact with the inner face of the central part 208 at the border in contact with the central part 208.

The upper edge 218 of the insertion area 210 and the upper edges 212 of the central part 208 form an oblong part. The oblong shape is contained in a plane inclined along the angle α relative to any horizontal plane.

The inner face of the central part 208 includes at least one coating made up of at least 95% natural rubber.

The central part 208 and the insertion area 210 delimit an inner volume.

The vibrating member 211 is configured to vibrate the central part 208 and the insertion area 210. The vibrating member 211 is for example in contact with the central part 208.

The rotary neck 202 is able to cause the material leaving the outlet neck 36 of the mixer 12 to enter the pouring channel 200.

The rotary neck 202 comprises an upper part 220, a lower part 222 and a transmission 224.

The upper part 220 and the lower part 222 are made in a single piece or are made in two separate parts, then attached to one another.

The upper part 220 is a hollow cylinder with a vertical axis as generatrix. The cylinder has a circular base.

The rotary neck 202 has, as main axis, the generatrix of the upper part 220.

The upper part 220 is connected at its upper end to the lower end of the funnel 72, forming the outlet of the outlet neck 36. The outlet of the outlet neck 36 and the upper end of the upper part 220 have the same shape and the same size.

The lower part 222 is a truncated cone extending between the upper part 220 and the insertion area 210 of the pouring channel 200. The radius of the cone decreases when the cone is traveled over from the upper part 220 to the insertion area 210. At the upper part 220, the cone has the same size as the upper part 220. At the insertion area 210, the lower part 222 rests on the upper edges 218. The cone is truncated at the insertion area 210 along a plane parallel to the axis X and forming an angle α with the horizontal.

The transmission 224 is able to rotate the lower part 222 and the upper part 220 of the rotary neck 202.

The transmission 224 comprises a motor 226 and a chain 228.

The motor 226 rotates a cylindrical pin 230, having a vertical axis as baseline.

The chain 228 circumnavigates the cylindrical pin 230 and the upper part 220 of the rotary neck 202. The chain 228 transmits the torque from the cylindrical pin 230 to the rotary neck 202.

The rotary neck 202 is rotated around the generatrix of the upper part 220.

The cap 204 is able to pour the substance outside the pouring channel.

The cap 204 comprises a body 232, a first ring 234, a second ring 236 and a valve 238.

The body 232 comprises a vertical wall 240 and a roof 242.

The vertical wall 240 defines an inner volume of the cap 204.

The vertical wall 240 is substantially in the form of a cylinder. The cylinder has a circular base and a vertical generatrix.

The vertical wall 240 has a thickness along the radius of the cylinder. The vertical wall 240 comprises a lower end and an upper end.

The vertical wall 240 is connected to the pouring channel 200 at the lower end 216 of the central part 208. The vertical wall 240 defines an opening in the continuation of the pouring channel 200. The lower end 216 of the central part 208 is included in the vertical wall 240.

The vertical wall 240 comprises two vertical slits 244 extending from the lower end of the vertical wall 240. The two slits are diametrically opposite on the vertical wall 240.

The roof 242 is a circle with the same radius as the circular base of the vertical wall 240. The roof 242 mounted on the upper end of the vertical wall 240.

The vertical wall 240 is hermetically sealed at its upper end by the roof 242.

The first ring 234 has a horizontal surface and a vertical surface.

The horizontal surface is a circular ring. The outer radius is a radius larger than the radius of the circular base of the vertical wall 240. The inner radius is a radius smaller than the radius of the circular base of the vertical wall 240 by a distance equal to the thickness of the vertical wall 240

The vertical surface defines an outlet channel of the cap 204.

The vertical surface is generally in the shape of a cylinder with a circular base. The circular base has, as radius, the inner radius of the horizontal surface. The cylinder has, as generatrix, the vertical axis passing through the center of the circular ring. The vertical surface has a lower end and an upper end.

The inner radius of the horizontal surface and the lower end of the cylinder of the vertical surface are in contact.

The vertical surface comprises two diametrically opposite through orifices 246.

The vertical surface of the first ring 234 is inserted inside the vertical wall 240 of the body 232 of the cap 204. The inner surface of the vertical wall 240 of the body 232 is in contact with the outer surface of the vertical surface of the first ring 234.

In the described example, the vertical surface has, at the lower end, a cutout complementary to the cutout at the lower end 216 of the central body 208 of the pouring channel 200.

The two through orifices 246 of the vertical surface of the first ring 234 are aligned with the slits 244 of the vertical wall 240 of the body 232.

The second ring 236 is a horizontal circular ring. The second ring 236 has an outer radius larger than the outer radius of the first ring 234. The second ring 236 has an inner radius comprised between the inner radius and the outer radius of the first ring 234.

The first ring 234 and the second ring 236 have the same center.

The second ring 236 is mounted with the first ring 234. The first ring 234 is situated between the body 232 of the cap 204 and the second ring 236.

The second ring 236 is intended to rest on the upper edge of a container.

The valve 238 is configured to allow a substance from the pouring channel 200 to leave the inner volume of the cap 204, or to prevent said substance from doing so.

The valve 238 comprises a disc 248, a rod 250 and a motor 252.

The disc 248 is a disc whose center is the center of the first ring 234 and whose radius is the radius of the vertical surface of the first ring 234.

The disc 248 is a stainless steel disc surrounded by a rubber seal.

The disc 248 is configured to penetrate the outlet channel of the first ring 234. When the disc 248 is horizontal, the disc 248 hermetically blocks the passage in the channel of the first ring 234.

The rod 250 traverses the disc 248 along one of its diameters, the two through orifices 246 of the first ring 234 and the slits 244 of the body 232.

The rod 250 is able to rotate along its main axis.

The disc 248 is secured in rotation with the rod 250 along the main axis of the rod 250.

The motor 252 is able to rotate the rod 250.

The motor 252 is connected to one end of the rod 250.

The motor 252 is configured to rotate the rod 250 between at least two positions: a closed position, in which the disc 248 hermetically blocks the passage in the channel of the first ring 234, and an open position. In the described example, in the open position, the disc 248 is vertical.

The motor 252 is also able to keep the rod 250 in the open position or the closed position.

The cap 204 is able to be moved between a position in which the cap 204 rests on the upper edge of a container accommodated by the conditioning unit, and a position in which the cap 204 is not aligned with the package carrousel 122. The cap 204 is secured to the rest of the pouring channel 200 in both positions.

The lid 206 is configured to hermetically close the pouring channel 200.

The lid 206 has a shape complementary to the pouring channel 200, so that the inner volume of the pouring channel 200 is closed.

In the described example, the lid 206 is substantially rectangular. The lid 206 is placed in contact with the pouring channel 200 at the upper edges 212, 218 of the pouring channel 200. The contact is done with a rubber seal.

The lid 206 defines a rectangular opening closed by a lead window. The rectangular opening is provided so that an operator is able to see a substance in contact with the pouring channel 200.

The washing system 207 is configured to wash the pouring channel 200.

The washing system 207 is a unit for sprinkling a liquid on the pouring channel 200.

The washing system 207 comprises at least one collector connected to a water distribution system.

The collector is formed by a main hose and outlets.

The main hose extends from the rotary neck 202 to the cap 204, through the pouring channel 200 to the outside of the inner volume of the upper end. The main hose extends over the roof 242 of the cap 204 in a circle with a radius comprised between 0.7 and 0.95 times the radius of the roof 242 of the cap 204.

The main hose defines outlet orifices at regular intervals.

The outlets connect the outlet orifices of the main hose to the inner volume of the pouring channel 200 or the cap 204. The outlets are secondary straight hoses.

The water treatment unit 20 is configured to collect the used wash and rinse water and to treat it so that it may be reused for washing and rinsing the conditioning device.

The water treatment unit 20 comprises a first vat 260, a second vat 261, a third vat 262, a first pump system 263, a second pump system 264 and an outlet system 265.

The first vat 260 comprises a first inner vat 266, a first outer vat 268, a first lid 270, a first grate 272, an agitating system 274 and a filling system 275.

The first inner vat 266 is a rectangular vat, having a length and a width, defining an inner volume. The first inner vat 266 comprises vertical walls and a bottom.

The first inner vat 266 comprises a first hermetic plate 275b. The first plate 275b has substantially the same dimensions as a vertical wall of the first inner vat 266.

The first plate 275b is placed in the inner volume of the first inner vat 266, parallel to the vertical wall whereof the first plate 275b has the same dimensions. The first plate 275b is spaced away from the bottom of the first inner vat 266 by a space comprised between 150 mm and 200 mm, and more particularly comprised between 175 mm and 180 mm. The first plate 275b delimits two volumes in the first inner vat 266 that only communicate with one another near the bottom of the first inner vat 266.

The first outer vat 268 is a rectangular vat, having a length and a width, defining an inner volume. The length and the width of the first outer vat 268 are respectively greater than the length and the width of the first inner vat 266. The first outer vat 268 comprises vertical walls and a bottom.

The first inner vat 266 is placed in the first outer vat 268.

The first lid 270 is a rectangular surface, with a width and length equal to the width and length of the first inner vat 266.

The first lid 270 rests on the vertical walls of the first inner vat 266.

The first lid 270 defines two orifices 276.

The first lid 270 defines a through opening 277. The opening 277 is configured to pour the rinse and wash water into the inner volume of the first inner vat 266.

The opening 277 is connected to a water recovery system. The water recovery system is for example a system that can be removably connected to the outlet channel of the cap 204.

The first lid 270, the first inner vat 266 and the first outer vat 268 are made from stainless steel.

The first grate 272 is configured to filter the water into the inner volume of the first inner vat 266 during gravitational decanting of the water.

The first grate 272 assumes the form of a rectangle in the form of a horizontal section of one of the two volumes defined by the first plate 275b.

The first grate 272 comprises holes with a diameter comprised between 3 mm and 6 mm.

The first grate 272 is placed in the inner volume of the first inner vat 266 on one side of the first plate 275b. The first grate 272 is parallel to the bottom of the first inner vat 266. The first grate 272 is suspended from the first lid 270.

The distance between the first grate 272 and the bottom is greater than the distance from the first plate 275b to the bottom by a distance equal to 3 mm to within 5%.

The agitating system 274 is able to agitate a liquid contained in the inner volume of the first inner vat 266. The agitating system 274 is in particular able to keep filled water contained in the inner volume of the first inner vat 266 in suspension.

The agitating system 274 comprises an agitating blade and a motor.

The agitating blade is elongated along a vertical main axis. The agitating blade extends from the lid 270 in the inner volume of the first inner vat 266 to a distance from the bottom of the first inner vat greater than the distance to the bottom of the first grate 272.

The motor is able to rotate the agitating blade around its main axis.

The filling system 275 is configured to fill the first inner vat 266 from a water distribution system.

The filling system 275 comprises a pump for supplying the first inner vat 266 with water. The supply pump is connected on the one hand to a water distribution system and on the other hand to an orifice 276 defined in the first cover 270.

The filling system 275 is configured to pour the water into the inner volume of the first inner vat 266, and the volume defined by the first plate 275b comprising the first grate 272.

The second vat 261 comprises a second inner vat 278, a second outer vat 280, a second lid 282 and a second grate 284.

The second inner vat 278 and the second outer vat 280 are respectively similar to the first inner vat 266 and the first outer vat 268. The second inner vat 278 comprises a second plate 285, identical and placed similarly to the first plate 275b of the first inner vat 266.

The second lid 282 is a rectangular surface, with a width and length equal to the width and length of the second inner vat 278.

The second lid 282 defines two orifices 286. The second lid 282 rests on the vertical walls of the second inner vat 278.

The second lid 282, the second inner vat 278 and the second outer vat 280 are made from stainless steel.

The second grate 284 is similar to the first grate 272. The second grate 284 is placed in the inner volume of the second inner vat 278 similarly to the first grate 272 in the first inner vat 266.

The third vat 262 comprises a third inner vat 288, a third outer vat 290, a third lid 292 and a third grate 294.

The third inner vat 288 and the third outer vat 290 are respectively similar to the first inner vat 266 and the first outer vat 268. The third inner vat 288 comprises a third plate 296, identical and placed similarly to the first plate 275b.

The third lid 292 is similar to the second lid 282. The third lid 292 defines orifices 297. The third lid 292 rests on the vertical walls of the third inner vat 288.

The third lid 292, the third inner vat 288 and the third outer vat 290 are made from stainless steel.

The third grate 294 is similar to the first grate 272. The third grate 294 is placed in the inner volume of the third inner vat 288, similarly to the first grate 272 in the first inner vat 266.

The first pump system 263 is able to transfer the water near the bottom of the first inner vat 266 to the top of the second inner vat 278.

The first pump system 263 comprises a first pump 298, a first inlet hose 300 and a first outlet hose 302.

The first pump 298 is situated outside the inner volume of the three vats 260, 261, 262. The first pump 298 is able to pump a substance from an inlet to an outlet. The inlet and the outlet are optionally reversible.

The first inlet hose 300 is a hermetic hose extending between two open ends.

A first end is placed in the inner volume of the first inner vat 266, in the volume defined by the first plate 275b not comprising the first grate 272. The first end is placed at a distance from the bottom equal to 40 mm to within 5%.

A second end is connected to the inlet of the first pump 298.

The first inlet hose 300 passes through one of the orifices 276 defined in the first lid 270.

The first outlet hose 302 is a hermetic hose extending between two open ends.

A first end is connected to one of the orifices 286 defined in the second lid 282. The first end is placed such that the exiting substance goes into the inner volume of the second inner vat 278, in the volume defined by the second plate 285 comprising the second grate 284.

A second end is connected to the outlet of the first pump 298.

The second pump system 264 comprises a second pump 304, a second inlet hose 306 and a second outlet hose 308.

The second pump 304 is situated outside the volume of the three vats 260, 261, 262. The second pump 304 is able to pump a substance from an inlet to an outlet. The inlet and the outlet are optionally reversible.

The second inlet hose 306 is a hermetic hose extending between two open ends.

A first end is placed in the inner volume of the second inner vat 278, in the volume defined by the second plate 285 not comprising the second grate 284. The first end is placed at a distance from the bottom equal to 40 mm to within 5%.

A second end is connected to the inlet of the second pump 304.

The second inlet hose 306 passes through one of the orifices 286 defined in the second lid 282.

The second outlet hose 308 is a hermetic hose extending between two open ends.

A first end is connected to one of the orifices 297 defined in the third lid 292. The first end is placed such that the exiting substance goes into the inner volume of the third inner vat 288, in the volume defined by the third plate 296 comprising the third grate 294.

A second end is connected to the outlet of the first pump 298.

The outlet system 265 is configured to reinsert the water treated by the water treatment unit 20 into the rinsing and washing system of the device.

The outlet system 265 comprises an outlet pump 310, a recovery hose 312 and a distribution hose 314.

The outlet pump 310 is situated outside the inner volume of the three vats 260, 261, 262. The outlet pump 310 is able to pump a substance from an inlet to an outlet. The inlet and the outlet are optionally reversible.

The recovery hose 312 is a hermetic hose extending between two open ends.

A first end is placed in the inner volume of the third inner vat 288, in the volume defined by the third plate 296 not comprising the third grate 294. The first end is placed at a distance from the bottom equal to 40 mm to within 5%.

A second end is connected to the inlet of the outlet pump 310.

The recovery hose 312 passes through one of the orifices 297 defined in the third lid 292.

The distribution hose 314 is a hermetic hose extending between two open ends.

A first end is connected to the outlet of the outlet pump 310.

A second end is connected to the water grid used for washing and rinsing of the device or to the liquid inlet 60 of the mixer 12.

Alternatively, the orifice 52 is defined at the center of the bottom 48 of the vat 26 and has a circular shape. The outlet 36 is a funnel extending around a vertical axis, between the orifice 52 of the bottom 48 of the vat 26 and a lower end defining an outlet of the outlet neck 36.

A method for conditioning radioactive waste implementing the device previously described will now be described.

The method comprises the following steps:
a step for conveying radioactive waste,
a step for conveying binder,
a first mixing step,
a step for conveying liquid,
a second mixing step,
a transfer step,
a filling step, and
a vibrating step.

During the step for conveying radioactive waste, a predetermined quantity of radioactive waste is conveyed into the mixer 12. The step for conveying radioactive waste is carried out by the waste intake member 14.

At the beginning of the step for conveying radioactive waste, the outlet neck 36 of the mixer 12 is in the closed position.

Radioactive waste is introduced into the lump breaker screw 76 via the material inlet. The radioactive waste is broken up by the lump breaker shaft, then conveyed to the material outlet of the lump breaker screw 76 by the rotating coreless screw.

Radioactive waste is introduced into the handling screw 78, 79. The handling screw 78, 79 conveys the radioactive waste to the vat 26 of the mixer owing to the rotating transfer rotor 106.

The weight indicator of the support 104 of the handling screw 78, 79 is able to measure the mass of the material in the handling screw 78, 79. The mass of the material introduced into the vat 26 of the mixer is obtained by weighing the loss of material of the handling screw 78, 79.

The waste intake member 14 is deactivated when the quantity of radioactive waste poured into the mixer 12 reaches a predetermined value. The step for conveying radioactive waste is complete.

At the end of the step for conveying radioactive waste, the inner volume 40 of the vat 26 of the mixer 12 contains a predetermined quantity of radioactive waste.

During the step for conveying binder, a predetermined quantity of binder is conveyed into the mixer.

At the beginning of the step for conveying binder 102, the outlet neck 36 of the mixer 12 is in the closed position.

Cement and sand are introduced into the vat 26 of the mixer through the cement inlet 54 and the sand inlet 58 in the two half-covers 28, 30 of the mixer 12. The quantity of cement and sand introduced into the vat 26 is known. The step for conveying binder stops when the quantity of cement and sand introduced into the vat 26 reaches a predetermined value.

In one embodiment, the cement and the sand are introduced by an intake member similar to the radioactive waste intake member 14.

At the end of the step for conveying binder, the inner volume 40 of the vat 26 of the mixer 12 contains a predetermined quantity of binder.

The steps for conveying radioactive waste and binder take place in parallel or one after the other.

During the first mixing step, the radioactive waste and the binder are mixed in the inner volume 40 of the vat 26 of the mixer.

The first mixing step takes place after the steps for conveying radioactive waste and binder. The first mixing step takes place in the inner volume 40 of the vat 26 of the mixer 12 with the mixing member 32.

At the beginning of the first mixing step, the inner volume 40 of the vat 26 of the mixer contains radioactive waste and binder. The outlet neck 36 of the mixer 12 is in the closed position.

The mixing member 32 is activated. The planetary rotating blades in rotation mix the radioactive waste and the binder in the inner volume 40 of the vat, i.e., the planetary rotating blades 66 stir the radioactive waste in the binder together.

The mixing of the radioactive waste in the binder is done for a predetermined length of time, comprised between 2 and 4 minutes.

At the end of the first mixing step, the inner volume 40 of the vat 26 comprises a prior mixture of radioactive waste and binder.

During the step for conveying liquid, a predetermined quantity of water and/or additive is conveyed into the inner volume 40 of the vat 26 of the mixer 12.

At the beginning of the step for conveying liquid, the outlet neck 36 of the mixer 12 is in the closed position and the inner volume 40 of the vat comprises a prior mixture of radioactive waste and binder.

The step for conveying liquid takes place after the first mixing step.

Water and/or additives are introduced into the inner volume 40 of the vat by the at least one liquid inlet 60. The quantity of water and/or additives introduced into the vat 26 is known. The step for conveying liquid stops when the quantity of water and/or additives introduced into the vat 26 reaches a predetermined value.

At the end of the step for conveying water, the inner volume 40 of the vat 26 comprises a predetermined quantity of water and/or additives and the prior mixture of radioactive waste and binder.

During the second mixing step, the prior mixture of radioactive waste and binder, and the liquid are mixed to form a mixture.

The second mixing step takes place after the step for conveying liquid. The second mixing step takes place in the inner volume 40 of the vat 26 of the mixer 12 with the mixing member 32.

At the beginning of the second mixing step, the inner volume 40 of the vat 26 of the mixer contains water and/or additives and the prior mixture of radioactive waste and binder. The outlet neck 36 of the mixer 12 is in the closed position.

The mixing member 32 is activated. The planetary rotating blades 66 in rotation mix the water and/or additives, and the prior mixture of radioactive waste and binder, in the inner volume 40 of the vat 26. The planetary rotating blades 66 stir the water and/or the additives, and the prior mixture of radioactive waste and binder, to form the mixture 122.

The second mixing is done for a predetermined length of time, comprised between 4 and 6 minutes.

At the end of the second mixing step, the inner volume 40 of the vat 26 comprises a prior mixture of radioactive waste, binder, water and/or additives.

During the transfer step, the mixture is transferred from the mixer 12 to a container accommodated by the conditioning unit 16.

The transfer step is carried out by the outlet neck 36 and the transfer member 18. The transfer step takes place after the mixing step.

At the beginning of the transfer step, the outlet neck 36 is in the closed position. The second ring 236 of the cap 204 of the transfer member 18 rests on the upper edge of a container accommodated by the conditioning unit. The inner volume 40 of the vat 26 contains the mixture of radioactive waste, binder, water and/or additives.

The outlet neck 36 of the mixer 12 is placed in the open position. The mixture of radioactive waste, binder, water and/or additives leaves the vat 26 through the outlet neck 36.

The mixture of radioactive waste, binder, water and/or additives is able to be poured into the transfer member 18. The mixture of radioactive waste, binder, water and/or additives is introduced into the pouring channel 200 of the transfer member 18 through the rotary neck 202.

The vibrating member 211 is activated. The vibrating member 211 mechanically vibrates the pouring channel 200.

The mixture is able to flow in contact with the pouring channel 200. The mixture flows to the cap 204.

At the end of the transfer step, the mixture is situated in the inner volume of the cap 204 at the valve 248 in the closed position.

During the filling step, the container is filled with mixture.

The filling step is carried out by the cap 204.

At the beginning of the filling step, the cap 204 rests on the upper edge of the container accommodated by the conditioning unit. The mixture is in the cap 204. The filling step takes place after the transfer step.

The valve 248 is placed in the open position.

The mixture enters the inner volume of the container through the outlet channel of the cap 204.

At the end of the filling step, the mixture is in the inner volume of the container.

During the vibrating step, a strong inner vibration is applied to the mixture in the container. The vibrating step is provided to increase the compactness of the mixture. A larger quantity of mixture, therefore radioactive waste, is then able to be stored in the container.

At the beginning of the vibrating step, the container is filled with the mixture. The cap 204 rests on the upper edge of the container.

The vibrating step takes place after the filling step.

The cap 204 is moved, such that the cap 204 is not aligned with the package carrousel 122. Then, the support 404 moves the vibrating needle(s) 400 into the vibrating position. The vibrating needle(s) 400 are then at least partially submerged in the mixture in the inner volume of the container. The vibrating needle 400 is such that its main axis X is parallel to the vertical of the location, therefore the main axis of the container.

The rotating system is activated. The weight is rotated around the main axis X by the vibrating needle 400 at a given frequency, for example comprised between 10,000 revolutions per minute and 20,000 revolutions per minute.

The activation of the vibrating needle(s) 400 causes a vibration of the mixture in the container, i.e., a strong internal vibration of the mixture. This increases the compactness of the mixture. The mixture then assumes a more compact arrangement.

In one embodiment, the support 404 moves the vibrating needle 400 within the mixture. Such an embodiment in particular corresponds to the case where there is no longer an immobile configuration of the vibrating needle(s), in which the vibrating needle(s) are able to vibrate the entire mixture.

When a release of air from the mixture ceases to be observed, the vibrating needle 400 is deactivated. The support 404 moves the vibrating needle(s) 400 into the idle position.

At the end of the vibrating step, the inner volume of the container comprises the mixture. The mixture is more compact than before the vibrating step.

The device for conditioning radioactive waste is washed regularly. For all that, the entire conditioning device is not fully washed at one time.

In the described example, a step for washing the transfer member 18 and the mixer 12 takes place at the end of each conditioning process.

At the beginning of the washing step, the cleaning member 34 of the mixer 12 and the washing system 207 of the transfer surface 18 are activated.

First, the inner volume 40 of the vat 26 and the pouring channel 200 are sprinkled with filled water. Filled water is water densified by solid fillers, in particular sand with a particle size equal to 0.4 mm to within 5%, cement fines with a diameter comprised between 50 and 60 μm or fusion dust. Secondly, the inner volume 40 of the vat 26 and the pouring channel 200 are rinsed with clean water.

In the next part of the washing step, the cleaning member 34 of the mixer 12 and the washing system 207 of the transfer member 18 are still activated. The inner volume 40 of the vat 26 and the pouring channel 200 are sprinkled with high-pressure clean water, the pressure being comprised between 10 and 20 MPa.

All of the waters used during the washing step are collected and treated by the water treatment unit 20.

The device for conditioning radioactive waste is able to carry out a method for conditioning radioactive waste. This results in automation of the method.

1. A device for inerting radioactive waste, comprising:
a mixer comprising a radioactive waste inlet,
a conditioning unit able to house a container,
a transfer member connecting the mixer and a container accommodated by the conditioning unit,
a handling screw, the handling screw comprising:
two ends, one end being connected to the radioactive waste inlet,
a cradle elongated along an axis between the two ends and delimiting an inner volume, the inner volume of the cradle being able to accommodate matter toward the mixer,
a transfer rotor, extending in the inner volume, and
a motor able to rotate the transfer rotor.

2. The device according to claim 1, wherein the transfer rotor of the handling screw comprises a polyurethane, Teflon or nylon coating.

3. The device according to claim 1, wherein the device further comprises a unit for measuring the mass of material accommodated in the inner volume delimited by the cradle.

4. The device according to claim 1, wherein the mixer comprises an inlet connected to a water intake and at least one inlet connected to an additive intake, the water intake and the additive intake comprising a system for metering a quantity of water and additive.

5. The device according to claim 1, wherein the transfer member comprises:
a pouring channel, the pouring channel having two ends, a first end of the pouring channel being connected to the mixer and the second end of the pouring channel being connected to a container accommodated by the conditioning unit,
a unit for sprinkling a liquid on the pouring channel, and
a vibrating member able to vibrate the pouring channel.

6. The device according to claim 5, wherein the pouring channel further comprises:
a neck, the neck being situated at the first end, the neck comprising a main axis and the neck being able to rotate around the main axis of the neck, and
a cap, the cap being situated at the second end and the cap comprising a valve having at least an open position and a closed position.

7. The device according to claim 1, wherein the conditioning unit comprises a package carrousel, the package carrousel comprising:
a chassis able to support a package, the chassis comprising rollers on which the package is intended to sit, and
a rotation unit able to rotate the package supported by the chassis.

8. The device according to claim 1, wherein the conditioning unit comprises vibrating needles.

9. The device according to claim 1, wherein at least part of the mixer and/or the transfer member has a coating made up of at least 95% natural rubber.

10. The device according to claim 1, wherein the mixer comprises:
a vat having an inner surface, and
a cleaning member able to send a liquid onto the inner surface.

11. The device according to claim 1, wherein the transfer rotor is a coreless screw.
